(19) United States
(12) Patent Application Publication
(10) Pub. No.: US 2026/0296238 A1
(43) Pub. Date: Oct. 1, 2026

(54) POWER DISTRIBUTION AND DIRECT CURRENT CHARGING

(71) Applicant: Amazon Technologies, Inc., Seattle, WA (US)

(72) Inventors: Kevin W. Keck, Edmonds, WA (US); Frances Hsing, Piedmont, CA (US); Tamir Peleg, Palo Alto, CA (US); Qiang Fu, Bellevue, WA (US); Mohit Malik, Seattle, WA (US); Bhavik Patel, Bellevue, WA (US); David Lee Coats, Bellevue, WA (US); Ronald Imbert, Shoreline, WA (US); Neeraj Valleru, Erie, CO (US); Joshua Traube, Seattle, WA (US)

(21) Appl. No.: 19/094,428

(22) Filed: Mar. 28, 2025

(51) Int. Cl. B60L 53/31; B60L 53/10; B60L 53/51; H02J 7/06

(52) U.S. Cl. CPC B60L 53/31; B60L 53/11; B60L 53/51; H02J 7/06; H02J 2207/20

(57) ABSTRACT

Systems and methods are disclosed for charging battery-powered vehicles based on direct current (DC) voltage. The systems may include a bidirectional inverter electrically coupled to an alternating current (AC) grid and a DC bus and a plurality of DC to DC converters electrically coupled to the DC bus to charge one or more battery-powered vehicles. The systems may cause the bidirectional inverter to convert AC voltage from the AC grid to DC voltage to be provided to the DC bus to charge one or more battery-powered vehicles. The systems may cause the bidirectional inverter to adjust the DC voltage to be inversely proportional to an amount of power to charge the one or more battery-powered vehicles electrically coupled to the plurality of DC to DC converters.

### BACKGROUND

Scaling a large charging infrastructure for vehicles, such as electric vehicles (EVs) or other battery-powered vehicles, can require multiple transformers to step down the high-voltage supply to voltage levels suitable for individual chargers. However, using multiple transformers can introduce complexity, increase costs, and require dedicated space and utility coordination to manage peak loads. As the number of chargers increases, the associated footprint, expense of transformers, and distribution equipment can increase. Accordingly, there exists a need to address at least these problems and provide additional benefits.

### BRIEF DESCRIPTION OF THE DRAWINGS

Various techniques will be described with reference to the drawings, in which:

FIG. 1 illustrates a system to power battery-powered vehicles using direct current (DC) voltage, according to at least one embodiment;

FIG. 2 illustrates a system to cold start a bidirectional inverter using at least one battery-powered vehicle, according to at least one embodiment;

FIG. 3 illustrates an example graph to describe ride-through performed by a charging system, according to at least one embodiment;

FIG. 4 illustrates a graph to describe droop control performed by a charging system, according to at least one embodiment;

FIG. 5 illustrates a process performed by at least one processor to cold start a bidirectional inverter using at least one battery-powered vehicle, according to at least one embodiment;

FIG. 6 illustrates a process performed by at least one processor to perform droop control, according to at least one embodiment;

FIG. 7 illustrates a process performed by at least one processor to perform ride-through, according to at least one embodiment;

FIG. 8 illustrates a process performed by at least one processor to start a bidirectional inverter, according to at least one embodiment; and

FIG. 9 illustrates a system in which various embodiments can be implemented.

### DETAILED DESCRIPTION

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

Apparatuses, systems, methods, processes, and software performed by one or more processors are described herein for a DC-based system that provides power to battery-powered vehicles (e.g., EVs, hybrid vehicles, fuel cell electric vehicles), DC motors, LED lights, computer systems, telecom devices, and other electronic systems or any other devices requiring DC power. Systems can include a fast charging station (FCS) that includes Charge Management System (CMS) and an Energy Management System (EMS) to orchestrate the charging of multiple battery-powered vehicles with optimized energy flow.

The systems can include AC grids to supply electrical energy to power electronic components, perform energy conversion (e.g., AC to DC), or charge an onboard battery for a vehicle. AC grids can supply medium voltage, ranging from 1 kV to 35 kV. In some examples, the AC grids can supply low voltage or high voltage. The AC grids can be electrically coupled to the transformers. The systems may include transformers, which can be an electromagnetic device comprising primary and secondary windings magnetically coupled through a core, configured to electrically isolate and adjust voltage levels between the bidirectional inverters. The transformers can decrease the AC voltage from the AC grids. For example, the transformers can covert medium voltage to between 480V and 800V.

The systems may include bidirectional inverters to convert AC electrical power to DC electrical power to generate a regulated DC bus. For example, the bidirectional inverters can convert 480Vac from the transformers to 800Vdc. The bidirectional inverter can be further configured to operate reversibly, converting DC power from the DC bus, supplied by batteries or vehicle energy storage systems, back into AC power for delivery to the AC grid or local AC loads. The DC bus is electrically coupled to a combiner box to distribute DC power to multiple chargers. The combiner box may include internal electrical connections, circuit protection devices, and distribution terminals, enabling safe, efficient, and simultaneous delivery of DC energy to chargers while ensuring protection against electrical faults, overload conditions, or abnormal operational events. The DC bus is electrically coupled to a combiner box to distribute DC power to multiple chargers. The combiner box may include internal electrical connections, circuit protection devices, and distribution terminals, enabling safe, efficient, and simultaneous delivery of DC energy to chargers while ensuring protection against electrical faults, overload conditions, or abnormal operational events. The combiner box may include temperature sensors to detect overheating or potential fire hazards. The combiner box may include voltage/current sensors to measure electrical parameters such as voltage, current, and power factor and/or to generate data to detect irregularities or faults in individual circuits, such as overloads, short circuits, or failures. The combiner box may include energy meters to track power consumption and to support load balancing. The systems may include chargers that receive DC electricity from a combiner box, and to regulate and condition the received DC power to appropriate voltage and current levels required to safely charge an electric vehicle's onboard battery. The charger may communicate with battery-charged vehicle's management system to optimize charging parameters, control charging rates, and ensure battery safety and longevity.

The systems (e.g., processor) may use transformers to decrease AC voltage from AC grids, which is then sent to the bidirectional inverter. When events such as power outages, grid disconnections, initial power-ups, or restarts of the whole system occur, the systems may determine that the DC voltage is below a threshold (e.g., below 40V, 250V, or 500V, depending on the degree of voltage handled by the bidirectional inverter). In response to this determination, the systems may identify a battery-powered vehicle that is plugged into one of the chargers within the systems. Subsequently, the systems may use switches to prevent other chargers from receiving power from the DC bus and/or the battery-powered vehicle, ensuring that the battery-powered vehicle does not inadvertently power other vehicles plugged into the other chargers. After configuring the circuits, the systems may use the battery-powered vehicle to load power to the DC bus to cause the voltage on the DC bus to exceed the threshold. As a result of determining that the voltage on the DC bus exceeds the threshold, the systems may use the bidirectional inverter to receive AC power from the transformers or the AC grid and convert it to DC power to energize the battery-powered vehicles, including the one used to power the DC bus during cold start. The systems may permit or allow the other chargers to receive power from the DC bus. Other auxiliary power sources (e.g., solar panels, batteries, hydro cells) can be used to provide load to increase the voltage on the DC bus.

The systems can perform ride-through, allowing the inverters to remain connected and operational during temporary power disturbances, such as short-duration voltage decreases (e.g., sags, dips, drops), voltage swells (e.g., overvoltage), frequency fluctuations, short-duration power interruptions on the AC grid, rather than shutting down immediately. The systems can monitor the grid voltage and identify whether a temporary decrease in voltage (e.g., due to a fault, switching event, or sudden load change) occurs. When such a temporary decrease happens, the systems can control the bidirectional inverter to maintain operation (e.g., converting AC voltage to DC voltage) for a predetermined period (e.g., 100 ms). In some examples, the bidirectional inverter may decrease power output. The predetermined period may depend on the percentage of voltage drop. For instance, if the voltage drop is significant, the predetermined period can be shorter. If the grid voltage recovers within the predetermined period, the bidirectional inverter can resume full operation. The recovered voltage can be lower than the voltage before the decrease. However, if the voltage remains low beyond the predetermined period, the systems may disconnect (e.g., electrically decouple) the bidirectional inverter for safety. The predetermined duration may depend on the percentage of the decrease; the lower the percentage, the shorter the predetermined duration.

The systems can perform a fuzzy logic-based droop control to install more chargers without upgrading the entire system capacity. The fuzzy logic may cause the voltage on the DC bus to be inversely proportional to the required power for the system. For example, when the load on the systems increases due to an increase in chargers within the system, or an increase in battery-charged vehicles, the systems can control the bidirectional inverter to decrease the voltage on the DC bus. Conversely, when the load on the systems decreases due to a decrease in chargers within the system, or a decrease in battery-charged vehicles, the systems can control the bidirectional inverter to increase the voltage on the DC bus. The fuzzy logic allows the systems to make more flexible adjustments in response to changes in voltage. This helps maintain stability and performance across a wider range of operating conditions and facilitates smoother transitions between different operating states. Additionally, the systems can perform a separate and distinct droop control for the chargers. For example, the load for individual chargers is proportional to the DC voltage. As a result, the systems can maintain stability in various situations while minimizing communication between the bidirectional inverter and the chargers.

As one skilled in the art will appreciate in light of this disclosure including the execution of battery-charged vehicle-based cold start, ride-through, and droop control for a DC-based charging system, certain embodiments may be capable of achieving certain advantages, including some or all of the following: (1) reducing the number of components like transformers and branch circuits enhances system efficiency, decreases latency, and lowers computing resource usage, resulting in a more responsive and reliable charging system; (2) minimizing heat transfer during charging protects battery-powered vehicles from thermal stress, improving safety, reliability, and energy efficiency; and (3) enhancing the stability of DC-based charging systems ensures consistent power delivery, reduces fluctuations, and supports the growing demand for battery-powered vehicles. Electrically coupled can refer to a connection between two or more electronic components that permits, allows, or otherwise enables the exchange of electrical power, signals, or control information, either directly or indirectly, through conductive, inductive, capacitive, optical, or wireless means (e.g., wires).

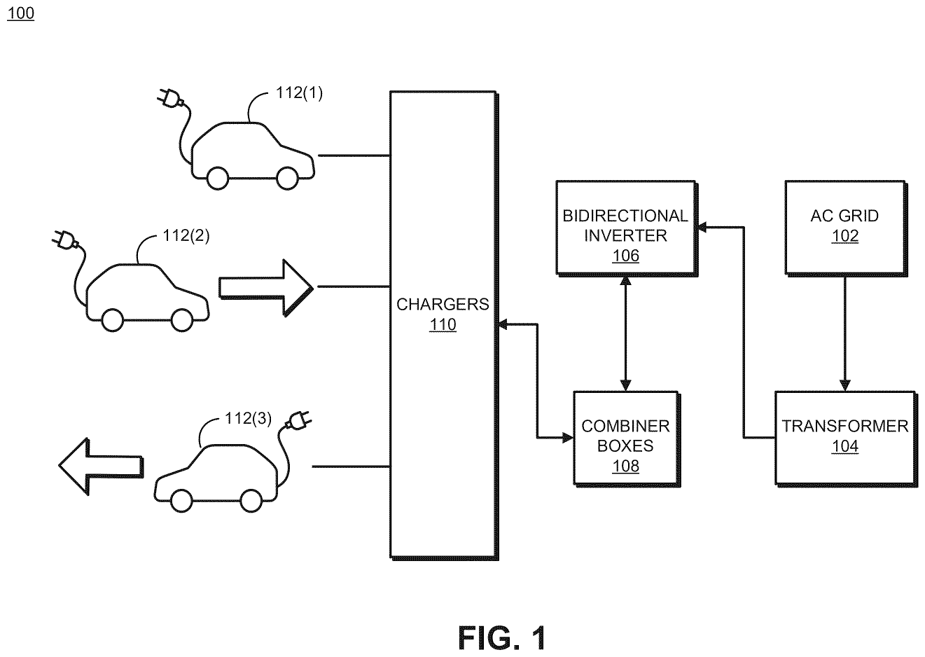

FIG. 1 illustrates system 100 to power up battery-powered vehicles using direct current (DC) voltage, according to at least one embodiment. System 100 may refer to a DC-based charging system to charge battery-powered vehicles. Charging may refer to the controlled transfer of electrical energy into an electrochemical energy storage system (battery) within the battery-powered vehicles described herein, resulting in an increase in the battery's stored energy level or state of charge (SOC). The charging process may include applying an external electrical current at a regulated voltage, causing electrochemical reactions that reverse the chemical processes occurring during battery discharge. This may replenish electrical capacity by moving ions within battery cells from a discharged state to a charged state. Charging may continue until a predetermined state of charge, voltage threshold, or other specified battery conditions are met, as managed and monitored by the vehicle's battery management system (BMS).

System 100 may include AC grid 102, transformer 104, bidirectional inverter 106, combiner boxes 108, chargers 110, and battery-charged vehicles (e.g., first battery-charged vehicle 112(1), second battery-charged vehicle 112(2), third battery-charged vehicle 112(3)). System 100 may include multiple AC grids 102, transformers 140, bidirectional inverters 106, combiner boxes 108, chargers 110, and battery-powered vehicles. For example, system 100 may include eight DC combiner boxes, one hundred chargers 110, and two hundred battery-powered vehicles that aren't explicitly illustrated in FIG. 1. Additionally, system 100 may increase the number of its components as it scales while meeting the requirements to ensure that system 100 is fully operational.

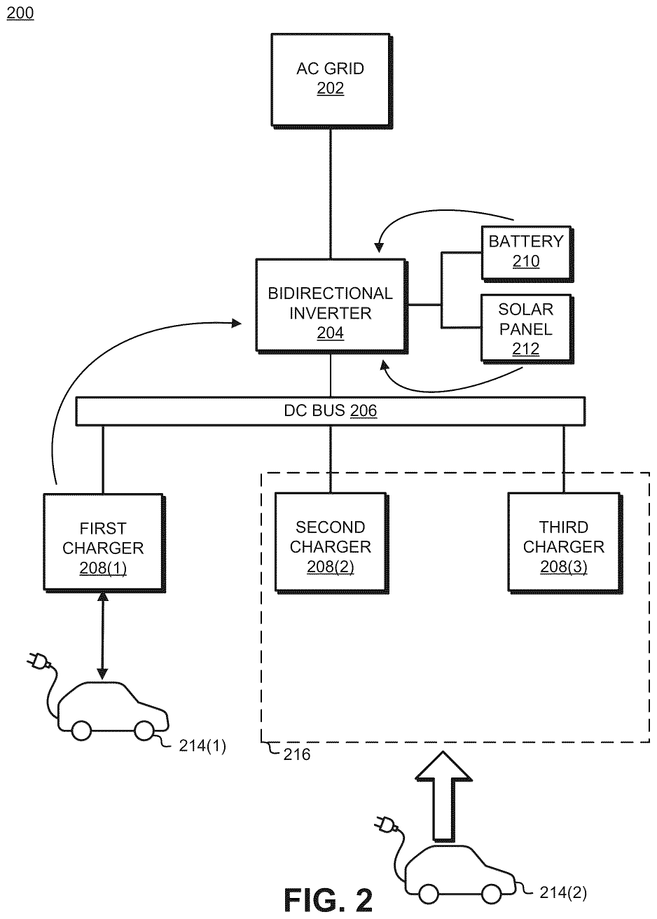

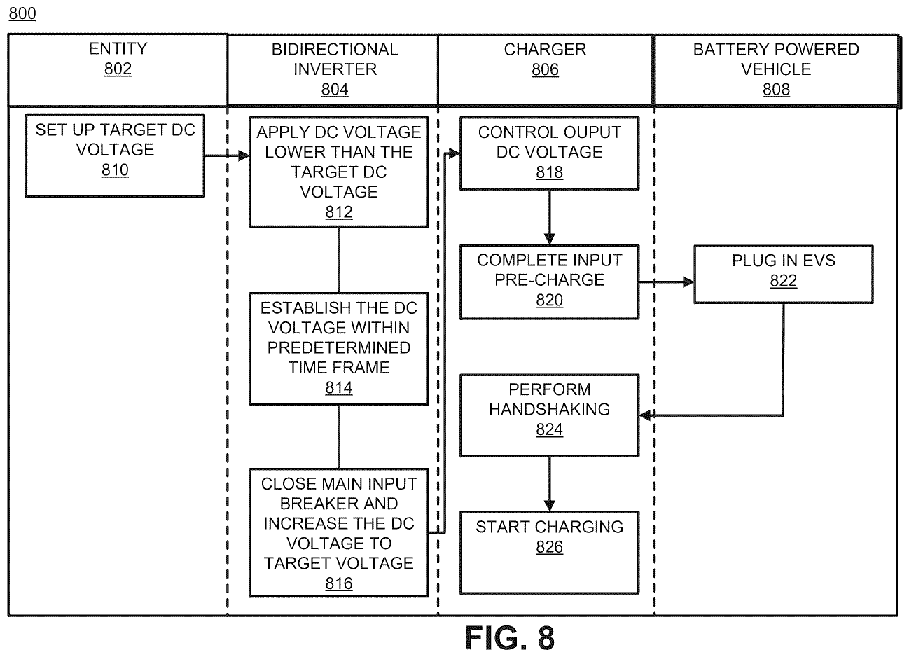

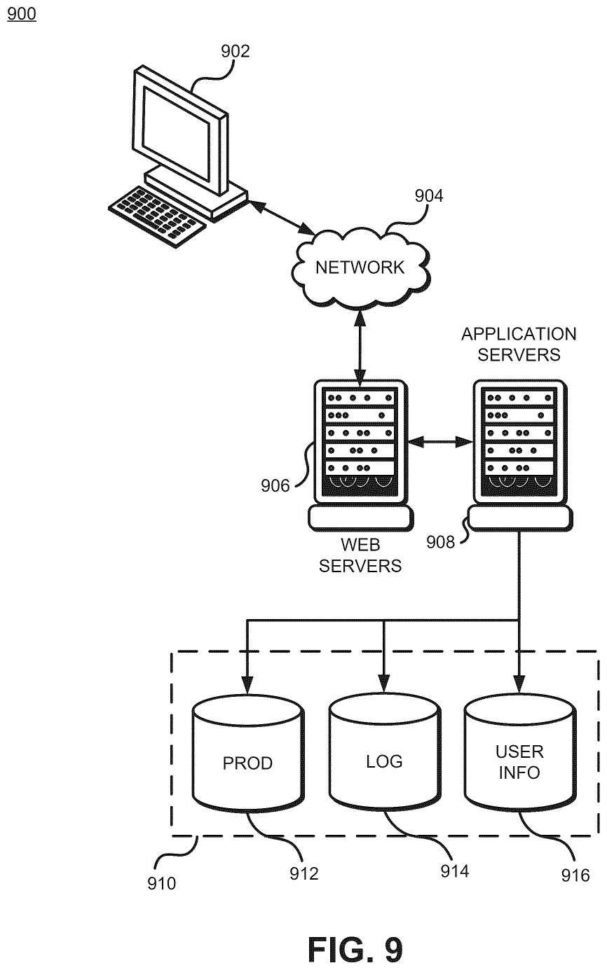

In at least one embodiment, one or more control systems can control each component of different systems described herein (e.g., system 100, system 200 illustrated in FIG. 1). The components may include AC grid 102, transformer 104, bidirectional inverter 106, combiner boxes 108, chargers 110, battery-powered vehicles (e.g., first battery-powered vehicle 112(1), second battery-powered vehicle 112(2), third battery-powered vehicle 112(3)), AC grid 202, bidirectional inverter 204, DC bus 206, chargers (e.g., first charger 208(1), second charger 208(2), third charger 208(3)), battery-powered vehicles (e.g., first battery-powered vehicle 214(1), second battery-powered vehicle 214(2)) illustrated in FIG. 2, entity 802, bidirectional inverter 804, charger 806, EV 808 illustrated in FIG. 8. The one or more control systems may include one or more components of system 900 illustrated in FIG. 9.

In at least one embodiment, the one or more control systems may include an Energy Management System (EMS) and a Charge Management System (CMS). In some examples, the EMS and CMS may be integrated into a centralized control platform, while in others, they may operate as distributed systems across separate physical unit.

In some examples, CMS may be configured to control and coordinate the charging of battery powered vehicles connected to a charging station (e.g., system 100, system 200 illustrated in FIG. 2) The CMS may identify one or more battery powered vehicles connected to chargers 110 and may collect vehicle-specific parameters including, but not limited to, battery capacity, state of charge (SoC), arrival time, and anticipated departure time. Based on this information, the CMS may generate a composite charging profile and may determine the total charging power required to fulfill the charging needs of all connected battery powered vehicles. The CMS can generate optimized charging schedules and may allocate available power resources accordingly to meet predefined operational or grid-related constraints.

The CMS may further use one or more scheduling and control algorithms to regulate charging behavior. For example, the CMS may execute charging logic based on first-come-first-served priority, equal power distribution across connected EVs, SoC-based fairness principles, or any other optimization techniques that consider real-time availability of distributed energy resources (DERs), electricity pricing signals, and vehicle-specific constraints. The CMS may monitor the operational status of individual chargers 110 and may dynamically reassign or curtail charging sessions based on load conditions, energy availability, or external signals from the EMS or grid operator. In some examples, the CMS can support bidirectional power flow (vehicle-to-grid or V2G) operations as described herein.

In other examples, EMS can be configured to monitor, control, and optimize the energy flow within a charging station (e.g., system 100, system 200 illustrated in FIG. 2). EMS may manage one or more local energy resources, including but not limited to solar photovoltaic (PV) generation systems, battery energy storage systems (BESS), and dispatchable generators. The EMS can determine the available energy capacity from these sources and may coordinate their operation to meet the real-time and forecasted charging demands of connected battery powered vehicles. Additionally, the EMS may control the import and export of energy at the POI with, and may regulate parameters such as active power (P), reactive power (Q), and voltage levels in accordance with utility requirements or interconnection agreements.

In addition, EMS may communicate with the CMS to receive load demands and charging schedules and can dispatch energy accordingly to satisfy those requirements while minimizing energy costs and reducing peak loads. The EMS may also be configured to provide ancillary grid services, such as frequency support, voltage regulation, and demand response. The EMS can support both grid-connected and islanded modes of operation and may manage transitions between these states as required. EMS can perform resource grouping, load forecasting, energy arbitrage, and the execution of grid-interactive algorithms.

In some examples, the one or more control systems may perform voltage ride-through (VRT), frequency ride-through (FRT), demand response (DR), and peak shaving. The one or more control systems may use protocols such as IEC 61850, IEEE 2030.5, and OpenADR to perform various operations. The one or more control systems may perform data archiving, event logging, and operational analytics for predictive maintenance and strategic energy optimization.

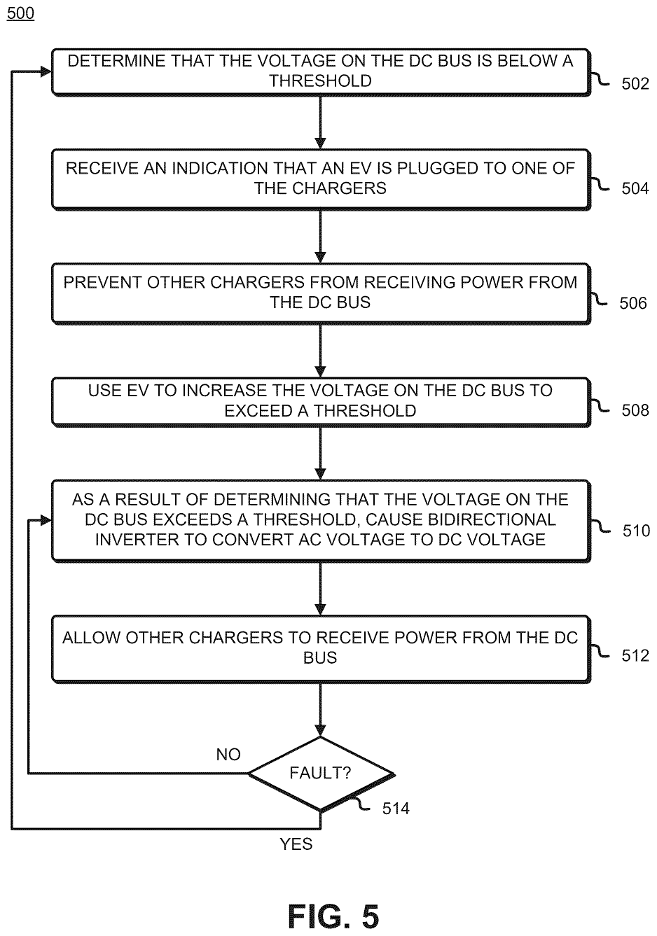

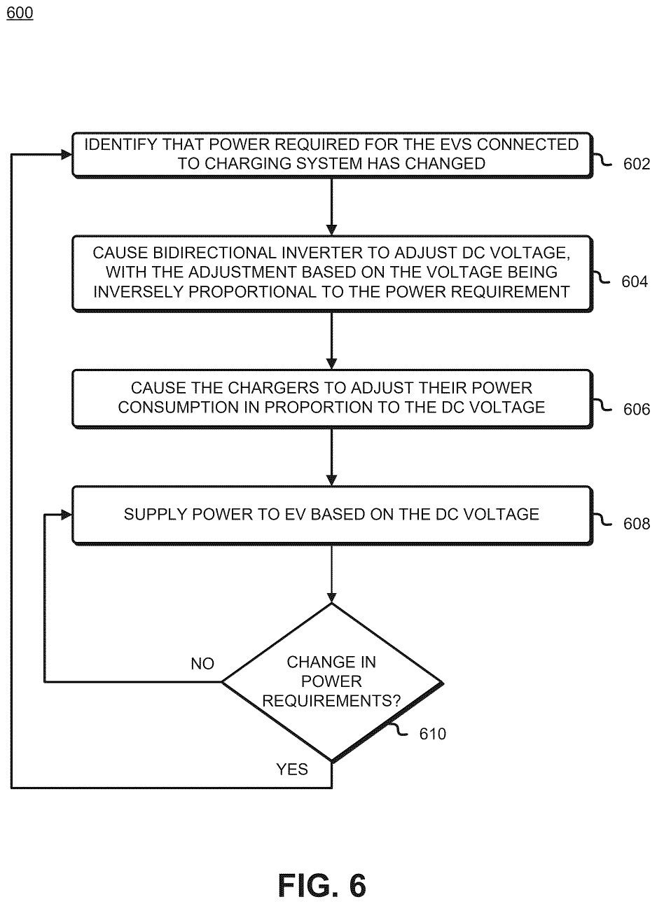

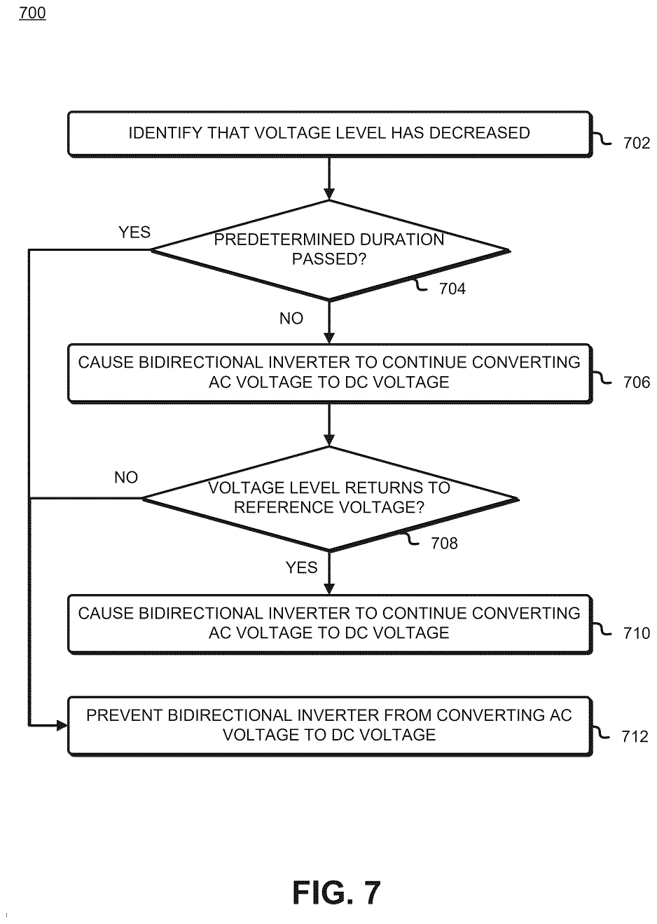

In at least one embodiment, the one or more control systems may include one or more general-purpose processors (e.g., x86, ARM, MIPS, Power, SPARC, RISC-V, VAX, Z80). The one or more control systems may include one or more hardware accelerators (e.g., graphics processing unit (GPU), field-programmable gate array (FPGA), application-specific integrated circuit (ASIC)). The one or more control systems may include memory (e.g., random access memory (RAM), cache memory, hard disk drive (HDD), solid-state drive (SSD), flash memory, read-only memory (ROM)). Memory can store one or more instructions that cause the one or more general-purpose processors or the one or more hardware accelerators, or both to perform various tasks and operations (e.g., process 500 illustrated in FIG. 5, process 600 illustrated in FIG. 6, process 700 illustrated in FIG. 7, process 800 illustrated in FIG. 8).

In at least one embodiment, the one or more control systems can be embedded in at least one of the components of the different systems. In other examples, the one or more control systems can be performed on a remote server or any other cloud system, and connected to the components via the internet, Bluetooth, or any other communication medium. In some examples, a first subset of control systems controls a group of components, while a second subset of control systems controls a single component. Different subsets of control systems can communicate with each other via the internet, Bluetooth, or any other communication medium to perform the steps.

In at least one embodiment, AC grid 102 may refer to electrical power distribution network that supplies alternating current (AC) electrical energy from power generation facilities—such as power plants, renewable energy installations (e.g., wind turbines or solar inverters), or distributed generation systems—to residential, commercial, industrial, or transportation applications such as charging battery-powered vehicles described herein. AC grid 102 may include power transmission lines, distribution transformers, substations, circuit breakers, protection systems, and metering equipment.

In at least one embodiment, transformer 104 may refer to an electrical device that transfers alternating current (AC) electrical energy from one circuit to another through electromagnetic induction, altering voltage and current levels between input and output circuits. Transformer 104 may comprise primary and secondary windings wrapped around a magnetic core, facilitating efficient transfer of energy by inducing a voltage in the secondary winding proportional to the turns ratio between primary and secondary windings. Transformer 104 may perform step-down function, which comprises reducing voltage from a higher input (primary side) to a lower output voltage (secondary side), simultaneously increasing current proportionally.

In at least one embodiment, bidirectional inverter 106 may refer to an electrical power conversion device to convert electrical energy between AC voltage and DC voltage. Bidirectional inverter 106 performs controlled transformation of AC power from AC grid 102 or transformer 104 into regulated DC power suitable for charging battery-powered vehicles described herein or powering DC loads, as well as the reverse conversion from DC sources, such as battery storage systems or renewable energy systems, into AC power compatible with electrical grids or AC loads. Bidirectional inverter 106 may comprises semiconductor switching elements (such as insulated-gate bipolar transistors (IGBTs) or metal-oxide-semiconductor field-effect transistors (MOSFETs)), filter components, control electronics, and protection circuitry, configured to perform rectification (AC-to-DC conversion) when drawing energy from the AC source, and inversion (DC-to-AC conversion) when supplying energy back to the AC grid or to AC-connected loads. In some examples, bidirectional inverter 106 may convert 480V (AC) to generate a 800V (DC) bus. In other examples, bidirectional inverter 106 may be electrically coupled to supplemental DC energy sources, such as solar panels, hydrogen fuel cells, auxiliary batteries, or other suitable energy storage devices, to provide the initial DC power required for a cold-start operation of bidirectional inverter 106.

In some examples, bidirectional inverter 106 may generate a DC bus where the range is, for example, between 700V and 1000V. The voltage on the DC bus can have peak-to-peak voltage less than 1% (or ±0.5% ripple). The voltage transient during a heavy step load condition (25% of full load) can be less than 2% voltage rise or sag and recovered within 100 ms. In various examples, 3% can be the maximum line drop allowed for cable sizing in the electrical design.

In various examples, bidirectional inverter 106 may perform protective functionalities to ensure operational reliability, safety, and compliance with industry standards. Such protective functionalities may include over-current protection to detect and isolate excessive current conditions; over-voltage and under-voltage protection to maintain voltage within safe operating thresholds; ground fault detection and isolation to mitigate electrical hazards; thermal (over-temperature) protection to prevent overheating damage to components; and short-circuit protection to quickly isolate faults.

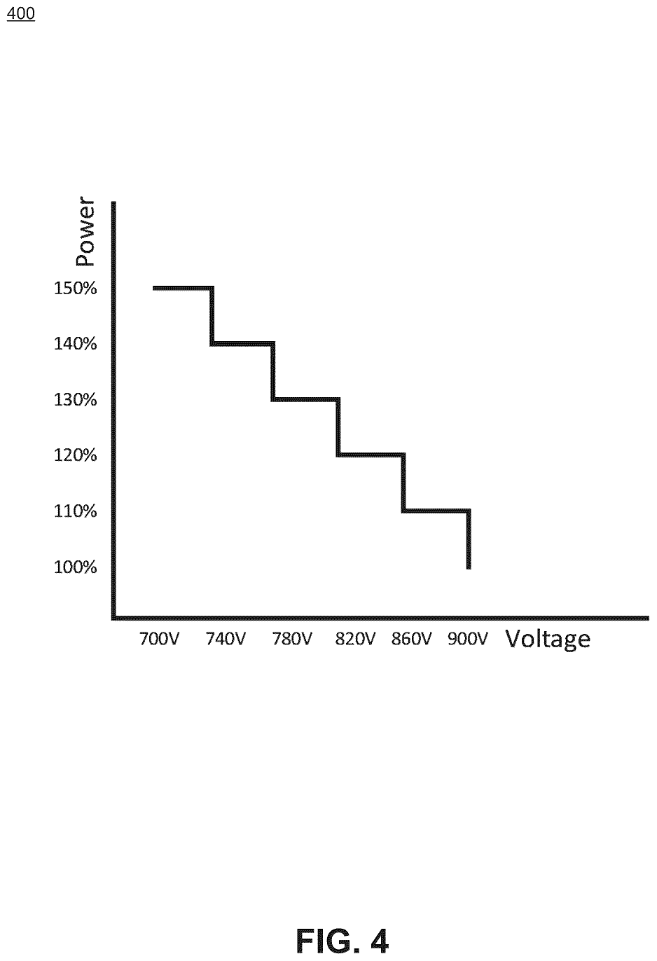

Additionally, bidirectional inverter 106 may perform DC bus fault ride-through protection, enabling system 100 to maintain operational stability during transient disturbances, such as brief but significant voltage sags resulting from short-circuit faults, temporary overloads, or other abnormal operating conditions within the system. Additional details of the ride-through protection are further described in conjunction with FIGS. 4 and 7.

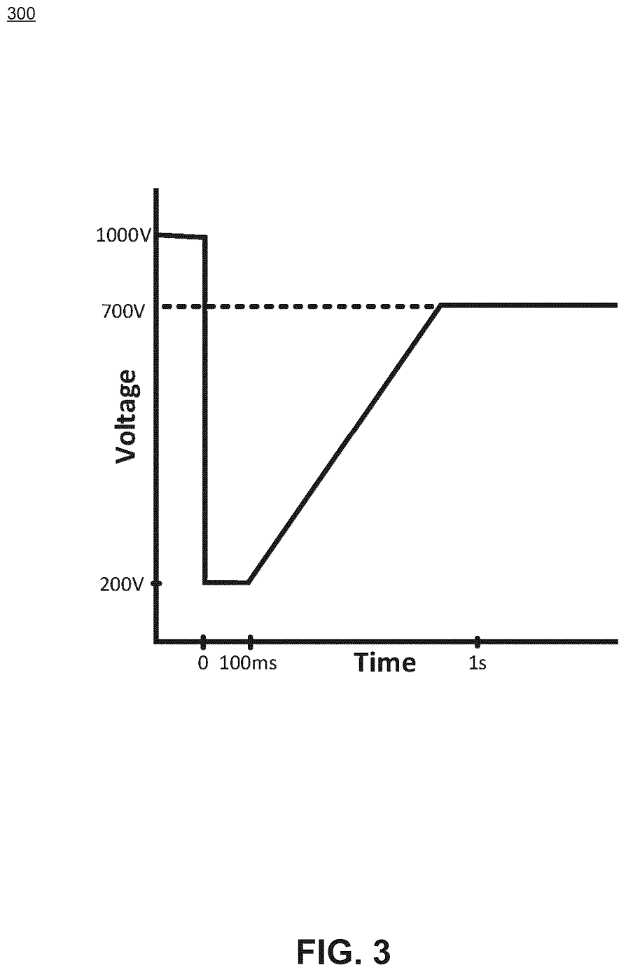

Moreover, bidirectional inverter 106 may perform a fuzzy logic-based droop control for dynamically managing power output within chargers 110, thereby enabling adaptive distribution of available electrical power to battery-powered vehicles that are connected without requiring an upgrade to overall system capacity. The fuzzy logic-based droop control may enhance energy management flexibility, allowing the charging system to efficiently accommodate seasonal demand variations, varying load conditions, and future expansions or increased numbers of chargers, without necessitating extensive infrastructure modifications. The fuzzy logic-based droop control is further described in conjunction with FIGS. 3 and 6.

In some examples, bidirectional inverter 106 can be configured to take auxiliary power from DC bus to operate. bidirectional inverter 106 can be used to start from AC grid 202 or from battery-powered vehicles for microgrid. In various examples, a rectifier can be electrically coupled with bidirectional inverter 106 and AC grid 102 to energize DC bus from AC grid 102 for inverter to start and then bypass it once the DC voltage is controlled and stabilized by the inverter, which requires communication between AC grid 102, bidirectional inverter 106, and/or the rectifier. Alternatively, bidirectional inverter 106 can use at least one of the battery-powered vehicles to receive power and energize the DC bus, with additional details provided in conjunction with FIGS. 2 and 5. Consequently, communication between different components of system 100, such as between the bidirectional inverter 106 and chargers 110, can be minimized. Bidirectional inverter 106 can be configured to automatically perform “start,” “stop,” and “restart.”

In some examples, bidirectional inverter 106 may include an isolation monitoring device (IMD) to the DC side, which may refer to an electrical protection instrument designed to continuously measure and evaluate the electrical insulation resistance between energized DC conductors (such as a DC bus) and the grounded or exposed conductive components within an electrical system. The isolation monitoring device may comprise precision measurement circuits, such as active DC voltage injection or impedance measurement methods, to detect deterioration or faults in insulation integrity. Upon detection of insulation faults, ground leakage, or abnormal isolation conditions below predetermined threshold values, the IMD may generate alarms, notifications, or initiates protective actions, such as isolating affected circuits. As long as the bidirectional inverter 106 is operational, DC power can be fed to the combiner boxes 108.

In at least one embodiment, combiner boxes 108 may refer to system that receives DC power from bidirectional inverter 106, consolidates and distributes the DC power into multiple protected output circuits for charging battery-powered vehicles or powering other DC loads. Combiner boxes 108 may include DC-rated circuit breakers or fuses to protect each output circuit from overcurrent conditions. Additionally, combiner boxes 108 may include disconnect switches to isolate individual circuits or the entire box for safe maintenance operations. Combiner boxes 108 also includes terminals or busbars specifically designed for secure wiring connections to DC-powered chargers or equipment. Furthermore, combiner boxes 108 may include integrated surge protection devices to safeguard downstream equipment against voltage spikes or transient events. Combiner boxes 108 may comprise monitoring equipment or sensors to measure and report voltage, current, and power flow conditions for system diagnostics or performance analysis. In various examples, each of combiner boxes 108 may independently manage its assigned DC circuits, allowing scalable, modular, and reliable power distribution within the overall DC charging infrastructure. Combiner boxes 108 may provide circuit distribution and electrical protections.

In at least one embodiment, chargers 110 may refer to a device configured to supply regulated DC electrical energy to recharge an onboard battery of the battery-powered vehicles when connected to an external power source. Chargers 110 can be bidirectional (e.g., usable to charge the battery-powered vehicles described herein and usable to use the battery-powered vehicles to charge one or more components within system 100, such as bidirectional inverter 106). Chargers 110 may include electric vehicle supply equipment (EVSE) or any other power providing devices to battery-powered vehicles. Chargers 110 may comprise a DC-to-DC converter designed to accept DC input voltage from other portions of system 100 (e.g., AC grid 102, transformer 104, bidirectional inverter 106, DC bus, combiner boxes 108) and provide a controlled DC output voltage and current tailored specifically to the battery chemistry and charging requirements of the battery-powered vehicles. Chargers 110 may include power electronics components including inductors, transformers, capacitors, switching transistors (such as MOSFETs or IGBTs), rectifiers, and feedback control circuits, enabling efficient voltage conversion, current regulation, isolation, and protection. Examples of DC-to-DC converter topologies used in these chargers may include buck (step-down), boost (step-up), buck-boost, flyback, forward, or resonant converters. Additionally, chargers 110 may perform integrated control algorithms, communication interfaces for vehicle-to-charger or charger-to-grid interactions, thermal management systems, and comprehensive safety operations to optimize charging efficiency, enhance battery longevity, and ensure compliance with industry standards and protocols.

In some examples, chargers 110 can include a 20-40 kW dual/quad-dispenser charger that converts a DC input voltage (e.g., 800V) to DC voltage required by the connected battery-powered vehicles (e.g., 200V-950V). This device uses standard communication protocols (e.g., ISO 15118, Open Charge Point Protocol (OCPP)) to manage the one or more control systems described herein, where the control systems may include vehicle Battery Management System (BMS), Charge-Point-Operator (CPO) systems, Charging station management system (CSMS) or Charging Network operator. The standard communication protocols can enable remote management, diagnostics, transaction handling, user authorization, firmware updates, smart charging control, secure data exchange, among others. Chargers 110 can be implemented with connector standards such as combined charging system type 1 (CCS1) and North American Charging Standard (NACS).

In various examples, chargers 110 can be implemented with a random delay start logic to reduce loading stress of the DC bus regulated by bidirectional inverter 106. One or more control systems associated with chargers 110 can generate randomized delay intervals (e.g., ranging from 1 to 120 seconds) prior to receiving DC power from bidirectional inverter 106. This randomized delay start-up procedure can enable sequential energizing of chargers 110, preventing simultaneous loading conditions that could cause voltage instability or excessive stress on bidirectional inverter 106 and associated DC bus components. Consequently, the randomized delay can maintain system stability, reduce the risk of overload conditions, and optimize overall reliability of the charging infrastructure. In some examples, battery-powered vehicles can be plugged into chargers 110 using wired connections or via wireless interfaces.

In at least one embodiment, system 100 may include a site controller system that can communicate with chargers 110 and bidirectional inverter 106 to manage and track the status of bidirectional inverter 106, chargers 110, and connected battery-powered vehicles. For example, the site controller system can receive status indicators of the battery-powered vehicles to determine which one is to be used for charging the DC bus, rather than selecting the one that was plugged into chargers 110 earlier than any other battery-powered vehicles. The site control system can control switches or any other circuit control hardware to select one or more of chargers 110 to be prevented from receiving power while another batter-power vehicle is supplying power to the DC bus. Additionally, the site controller system can manage the sequence of the battery-powered vehicles to supply power. The site controller system can manage the amount of charging of the battery-powered vehicles based on their collective statuses or the individual status of each battery-powered vehicle. The site controller system can be part of the one or more control systems described herein. The site controller system can comprise one or more processors (e.g., CPU) and memory.

In some examples, the site controller system can adjust the charging or discharging behavior of each connected battery-powered vehicles based on a set of predefined thresholds, available power capacity, and the operational status of other battery-powered vehicles within system 100. For example, if there are three battery-powered vehicles connected to chargers 110, the site controller system may initiate charging only for battery-powered vehicle #1 at a first time instance. Upon detecting that the terminal voltage of battery-powered vehicle #1 has reached a first predefined threshold (e.g., 80% state of charge or a specified voltage level), the site controller system may activate charging for battery-powered vehicle #2, while continuing to supply power to battery-powered vehicle #1. Once the site controller system determines that both battery-powered vehicle #1 and battery-powered vehicle #2 have reached respective thresholds or charging current has decreased below a certain level, the controller may then enable charging for battery-powered vehicle #3. This sequential activation may allow for load balancing, reduced peak demand, and optimized charger utilization, particularly in limited-power environments or microgrid configurations.

In other examples, the site controller system can manage the voltage levels allocated to each of chargers 110 dynamically. For instance, when all three battery-powered vehicles are charging concurrently, the site controller system may limit each charger to a predefined Level 1 operating voltage to maintain stable system load. If one for battery-powered vehicle (e.g., for battery-powered vehicle #2) disconnects or completes its charging session, the site controller system automatically increase the voltage available to the remaining chargers to a higher Level 2 setting, thereby reducing charge time for the remaining for battery-powered vehicles. This voltage reassignment may be based on real-time power availability, charger capacity, and vehicle-specific charging profiles. The site controller system can also prioritize certain for battery-powered vehicles based on user preferences, departure time, or emergency conditions.

In various examples, site controller system can may be implemented as part of the CMS described herein and may interface with the EMS described herein to receive additional constraints or energy flow data from upstream resources such as the electrical grid, on-site renewable energy sources, or battery energy storage systems (BESS). The controller may be further configured to execute control logic using programmable algorithms that account for load shedding, vehicle-to-grid (V2G) availability, and system reliability requirements.

In at least one embodiment, battery-powered vehicles (e.g., first battery-powered vehicle 112(1), second battery-powered vehicle 112(2), third battery-powered vehicle 112(3)) may refer to any mode of transportation propelled primarily or exclusively by electric energy stored in onboard rechargeable battery packs. Such vehicles typically comprise an electric motor or multiple motors directly powered by these batteries, associated power electronics including motor controllers and converters, and a battery management system configured to optimize energy efficiency, power delivery, charging, and discharging cycles. Examples may include, but are not limited to, EVs, trucks, buses, motorcycles, bicycles, scooters, drones, unmanned aerial vehicles (UAVs), marine vessels, or automated robotic vehicles. These battery-powered vehicles may utilize various battery chemistries including lithium-ion, lithium-polymer, nickel-metal hydride, solid-state, or future-developed electrochemical storage technologies, and may employ regenerative braking systems and advanced energy recovery methods for enhanced operational efficiency.

In some examples, chargers 110 may charge the first battery-powered vehicle 112(1), which is already connected to the chargers 110. The second battery-powered vehicle 112(2) is approaching system 100 to be charged. The third battery-powered vehicle 112(3) is departing from system 100 after being charged.

In at least one embodiment, a neural network or other machine learning model (e.g., transformer neural network, convolutional neural network) can be implemented by one or more processors to monitor, optimize, and otherwise control the operation of system 100. For example, the neural network can process real-time data from system components, including the bidirectional inverter 106, DC bus, chargers 110, and battery-powered vehicles 112(1)-112(3), to predict power demands, detect faults, and dynamically adjust charging parameters. As another example, by continuously analyzing voltage, current, and state-of-charge (SOC) levels, the neural network can be used by a controller to adjust the DC voltage output, manage load balancing among chargers 110, and implement predictive maintenance. The neural network can assist in fault detection by identifying abnormal fluctuations in voltage or current, allowing for rapid system responses such as rerouting power, isolating faults, or adjusting the charging schedule to prevent failures.

To train the neural network, historical and real-time operational data from system 100 can be used. Supervised learning techniques may involve training the model on labeled datasets, where input parameters such as grid voltage, battery SOC, charging power, and thermal conditions are correlated with optimal control decisions. Alternatively, reinforcement learning can be employed, where the model continuously improves its decision-making process by receiving feedback based on energy efficiency, charging speed, and system stability. The training process may also incorporate simulation-based learning, where various charging scenarios—including peak demand conditions, system faults, and varying vehicle loads—are simulated to optimize neural network performance before deployment. Once trained, the neural network may be deployed within edge computing hardware embedded in system components or processed in a cloud-based control system, allowing for real-time inference and adaptive optimization of the DC-based charging system.

FIG. 2 illustrates system 200 to cold start a bidirectional inverter using at least one battery-powered vehicle, in accordance with at least one embodiment. System 200 may refer to a DC-based charging system to charge battery-powered vehicles. System 200 may include AC grid 202, bidirectional inverter 204, DC bus 206, chargers (e.g., first charger 208(1), second charger 208(2), third charger 208(3)), and battery-charged vehicles (e.g., first battery-charged vehicle 214(1), second battery-charged vehicle 214(2)).

In at least one embodiment, AC grid 202 may refer to electrical power distribution network that supplies alternating current (AC) electrical energy from power generation facilities—such as power plants, renewable energy installations (e.g., wind turbines or solar inverters), or distributed generation systems—to residential, commercial, industrial, or transportation applications such as charging battery-powered vehicles described herein. AC grid 202 may include power transmission lines, distribution transformers, substations, circuit breakers, protection systems, and metering equipment. In some examples, AC grid 202 may include AC grid 102 illustrated in FIG. 2. AC grid 202 may supply AC power to bidirectional inverter 204. Before supplying AC power to the bidirectional inverter 204, the AC grid 202 may deliver the AC power to one or more transformers (e.g., transformer 104 illustrated in FIG. 1) to step down the AC power one or more times before providing the reduced AC power to bidirectional inverter 204.

In at least one embodiment, bidirectional inverter 204 may refer to an electrical power conversion device to convert electrical energy between AC voltage and DC voltage. Bidirectional inverter 204 may perform controlled transformation of AC power from AC grid 102 or the one or more transformers into regulated DC power suitable for charging battery-powered vehicles described herein or powering any other DC loads, as well as the reverse conversion from DC sources, such as battery storage systems or renewable energy systems, into AC power compatible with electrical grids or AC loads. Bidirectional inverter 204 may comprise semiconductor switching elements (such as insulated-gate bipolar transistors (IGBTs) or metal-oxide-semiconductor field-effect transistors (MOSFETs)), filter components, control electronics, and protection circuitry, configured to perform AC-to-DC conversion when drawing energy from the AC source, and DC-to-AC conversion when supplying energy back to the AC grid or to AC-connected loads. In some examples, bidirectional inverter 204 may include bidirectional inverter 106 illustrated in FIG. 1. Bidirectional inverter 204 is electrically coupled to DC bus 206.

In at least one embodiment, DC bus 206 may refer to an electrical conductor or conductor system that receives DC power from bidirectional inverter 204 and delivers this DC power directly to multiple connected chargers or other DC-powered loads, providing a centralized distribution pathway to efficiently manage and supply electrical energy within system 200.

In at least one embodiment, a cold-start condition in system 200 may occur when the DC bus voltage is initially insufficient or absent, preventing bidirectional inverter 204 from safely connecting to and receiving AC power from the AC grid. This situation can arises after prolonged system inactivity, during initial system startup, following maintenance or servicing activities. Additionally, faults such as short circuits, overloads, or component failures within one or more components of system 200 may trigger protective shutdown mechanisms, intentionally isolating the DC bus to prevent equipment damage. This protective isolation can result in loss or significant reduction of DC bus voltage, thereby causing system 200 to enter a cold-start condition.

One or more control systems can identify that system 200 entered a cold-start condition because voltage on DC bus 260 is below a threshold. In various examples, supplemental DC sources, such as first battery-powered vehicle 208(1) plugged into the first charger 208(1), can be used to pre-charge or energize the DC bus, thereby establishing a stable and adequate voltage level. Specifically, DC bus 206 may be configured with DC-rated contactors, relays, or semiconductor switches, to selectively restrict power distribution from the first charger 208(1), connected to the first battery-powered vehicle 208(1), to other chargers within the system (e.g., second charger 208(2) and third charger 208(3)). This selective isolation may prevent scenarios where first battery-powered vehicle 208(1) unintentionally energizes or charges other battery-powered vehicles (e.g., second battery-powered vehicle 214(2)) connected through DC bus, thereby ensuring controlled power flow, maintaining system safety, and preserving energy within each battery-powered vehicle for intended operations or cold-start purposes.

Once the voltage on DC bus 260 reaches the required threshold, the one or more control systems can perform one or more instructions to cause bidirectional inverter 204 can safely synchronize with AC grid, 202 subsequently allowing the normal battery charging process and system operation to resume. The one or more control systems can allow or permit the other chargers 206 to receive power from DC bus 206.

In at least one embodiment, chargers (e.g., first charger 208(1), second charger 208(2), third charger 208(3)) may refer to a device configured to supply regulated DC electrical energy to recharge an onboard battery of the battery-powered vehicles when connected to an external power source. The chargers may comprise a DC-to-DC converter designed to accept DC input voltage from other portions of system 100 (e.g., AC grid 102, transformer 104, bidirectional inverter 106, DC bus, combiner boxes 108) and provide a controlled DC output voltage and current tailored specifically to the battery chemistry and charging requirements of the battery-powered vehicles. The chargers may include power electronics components including inductors, transformers, capacitors, switching transistors (such as MOSFETs or IGBTs), rectifiers, and feedback control circuits, enabling efficient voltage conversion, current regulation, isolation, and protection. Examples of DC-to-DC converter topologies used in these chargers may include buck (step-down), boost (step-up), buck-boost, flyback, forward, or resonant converters. Additionally, the chargers may perform integrated control algorithms, communication interfaces for vehicle-to-charger or charger-to-grid interactions, thermal management systems, and comprehensive safety operations to optimize charging efficiency, enhance battery longevity, and ensure compliance with industry standards and protocols. In some examples, chargers may include chargers 110 illustrated in FIG. 1.

In some examples, the chargers may use ISO 15118 or DIN 70121 to communicate set points with individual battery-powered vehicles, and open charge point protocol (OCPP), Modbus, Distributed Network Protocol 3(DNP3), Open Platform Communications Unified Architecture (OPC-UA) or other industrial protocol to communicate metering, status, set point, and other data of chargers to local and/or remote control systems (e.g., Local Proxy, CPO, CNO, CSMS, EMS). The set point may refer to a process to exchange target charging parameters during a charging session.

In at least one embodiment, battery-powered vehicles (e.g., first battery-powered vehicle 214(1), second battery-powered vehicle 214(2)) may refer to may refer to any mode of transportation propelled primarily or exclusively by electric energy stored in onboard rechargeable battery packs. Such vehicles typically comprise an electric motor or multiple motors directly powered by these batteries, associated power electronics including motor controllers and converters, and a battery management system configured to optimize energy efficiency, power delivery, charging, and discharging cycles. Examples may include, but are not limited to, EVs, trucks, buses, motorcycles, bicycles, scooters, drones, UAVs, marine vessels, or automated robotic vehicles. These battery-powered vehicles may utilize various battery chemistries including lithium-ion, lithium-polymer, nickel-metal hydride, solid-state, or future-developed electrochemical storage technologies, and may employ regenerative braking systems and advanced energy recovery methods for enhanced operational efficiency.

First battery-powered vehicle 214(1) can be a vehicle that was plugged into the first charger 208(1) when system 200 met cold start conditions and was used to provide power to the DC bus 206. Other battery-powered vehicles, such as the second battery-powered vehicle 214(2), can be vehicles that were prevented from charging by the group of chargers in system 200 (e.g., second charger 208(2), third charger 208(3)) until the DC bus 206 is fully energized, allowing bidirectional inverter 204 to convert AC power from the AC grid 202 to DC power for vehicle charging. In some examples, any battery-powered vehicles that isn't explicitly illustrated in FIG. 2 can be used to cold start system 200.

In at least one embodiment, battery 210 may refer to an auxiliary energy storage device configured to provide initial DC electrical energy to pre-charge or energize DC bus 206, thereby establishing the necessary DC voltage level required by the bidirectional inverter to safely and effectively synchronize with, and subsequently accept AC power from, AC grid 202 during a cold-start or initial startup condition. Additionally, solar panel 212 may refer to a photovoltaic energy source configured to initially supply DC electrical energy to pre-charge or energize the DC bus, establishing the necessary DC voltage required by the bidirectional inverter to safely synchronize with, and subsequently accept AC power from, AC grid 202 during a cold-start or initial startup condition. Solar panel 212 or battery 210 can be coupled with a rectifier to provide DC power to DC bus 206. Electrical energy from battery 210, solar panel 212, or both can be used as supplemental power when charging DC bus 206 if one of the battery-powered vehicles (e.g., the first battery-powered vehicle 214(1)) is not operational.

In at least one embodiment, a cold start refers to a condition where the DC bus voltage is initially insufficient or absent, preventing the bidirectional inverter 204 from safely connecting to and drawing power from the AC grid 202. This situation can occur after prolonged system inactivity, initial system startup, maintenance or servicing, or protective shutdowns triggered by faults such as short circuits, overloads, or component failures. As disclosed in FIG. 2, to resolve a cold-start condition, one or more processors using software can detect that the DC bus voltage is below a threshold and initiate a recovery process. System 200 may include DC-rated contactors, relays, or semiconductor switches to selectively restrict power distribution from the first charger to other chargers. This controlled approach allows system 200 to safely restore operation and reconnect the bidirectional inverter 204 to the AC grid.

In at least one embodiment, battery-powered vehicles (e.g., first battery-powered vehicle 214(1) may include a power outlet or adapter interface designed to supply DC power to system 200, e.g., for initiating a cold start. This power outlet may be a high-power DC connector, such as a CHAdeMO, CCS, or bidirectional interface, capable of delivering regulated DC voltage to DC bus 206. The outlet may include pronged terminals or high-current contactors to establish a secure electrical connection with a corresponding inlet on a charger or directly to the DC bus. To enable controlled power flow, the adapter may incorporate solid-state relays, metal-oxide-semiconductor field-effect transistor (MOSFET) switches, or mechanical contactors that only close when proper handshake signaling is established between the battery-powered vehicles and system 200.

Battery-powered vehicles may include onboard power electronics and control system to facilitate real-time communication with bidirectional inverter 204 or a control unit within system 200 via CAN bus, Ethernet, or wireless protocols (e.g., Wi-Fi, Bluetooth). For example, this can cause power transfer to be initiated when system 200 detects a cold-start condition and verifies that the battery-powered vehicles have sufficient charge to supply the required startup power. In some examples, the adapter may include status LEDs, a touchscreen interface, or physical switches to allow an operator to manually authorize or configure the power transfer. Once DC bus 206 is energized to the necessary voltage threshold, bidirectional inverter 204 can resume normal operation, and the battery-powered vehicles can discontinue power supply, ensuring efficient and controlled cold-start recovery of the charging system.

FIG. 3 illustrates example graph 300 to describe ride-through by a charging system (e.g., system 100 illustrated in FIG. 1, system 200 illustrated in FIG. 2). The system may start at a high voltage level of 1000V on DC bus (e.g., DC bus 206 illustrated in FIG. 2), indicating normal operation. At the beginning of graph 300, a sudden decrease to 200V occurs, representing a disturbance or interruption in the power supply. The system may maintains this low voltage level for a brief period of 100 ms. Specifically, bidirectional inverters (e.g., bidirectional inverter 106 illustrated in FIG. 1, bidirectional inverter 204 illustrated in FIG. 2) can continue converting AC power from AC grid (e.g., AC grid 102 illustrated in FIG. 1, AC grid 202 illustrated in FIG. 2). During this time, the ride-through feature allows the system to continue operating without shutting down, despite the reduced voltage.

After the initial decrease, the voltage on the DC bus gradually increases back to a stable level of 700V over the next 900 ms. In some examples, 700V can be a reference voltage that is lower than the high voltage level maintained during normal operations. This recovery phase can ensure that the system can return to normal operation smoothly. Once the voltage on the DC bus stabilizes at 700V, the system can continue to operate effectively. The ride-through feature can prevent disruptions in the charging process, ensuring that the vehicle's battery can continue to charge even during brief power supply issues.

However, if the voltage disturbance persists and the voltage does not return to a stable operational range within the predefined period, the charging system can initiate protective or fallback measures. These protective measures may include isolating or disconnecting critical system components, such as chargers, the DC bus, or bidirectional inverter circuits, thereby preventing potential equipment damage or unsafe operating conditions. The isolation may be achieved through activation of protective relays, DC-rated circuit breakers, contactors, or semiconductor-based switching devices.

In response to sustained undervoltage conditions, the charging system may further transition into a controlled standby mode or perform a safe, orderly shutdown procedure. This action may prevent prolonged exposure to harmful voltage levels or unstable operating conditions. Additionally, the system may generate and transmit fault notifications, alarms, or diagnostic information, alerting maintenance personnel or automated management systems to the sustained abnormal condition, facilitating timely investigation, corrective actions, and restoration of normal system operations.

FIG. 4 illustrates example graph 400 to describe droop control performed by a charging system (e.g., system 100 illustrated in FIG. 1, system 200 illustrated in FIG. 2). In some examples, one or more components of DC-based battery-powered vehicle charging systems (e.g., system 100 illustrated in FIG. 1, system 200 illustrated in FIG. 2) can peform droop control to stabilize the DC-based battery-powered vehicle charing system. Specifically, as the power requirement increases due to various factors, such as changes in the number of battery-powered vehicles connected, variations in the number of chargers within the charging system, or differences in battery capacity of the battery-powered vehicles currently plugged into the charging system, the DC power output from bidirectional inverters (e.g., bidirectional inverter 106 illustrated in FIG. 1, bidirectional inverter 204 illustrated in FIG. 2) may adjust accordingly. More particularly, the DC power supplied by the bidirectional inverters may vary inversely in response to the available DC power from battery-powered vehicles, to meet the overall demand within the DC-based battery-powered vehicle charging system.

Graph 400 may indicate a fuzzy logic used by the bidirectional inverters to manage the relationship between the power requirements and the DC voltage. This can be to effectively handle the inherent complexity, uncertainty, and variability within the charging systems. Specifically, the bidirectional inverters can adapt to imprecise inputs, varying operating conditions, and dynamic scenarios such as fluctuating charger demands, differing battery states of charge, temperature variations, or unpredictable load behaviors.

Initially, the system can operate at an elevated power output of approximately 150% at a voltage level of 700V, representing its maximum operational capacity and establishing a baseline reference point for the droop control method. As the voltage progressively increases from 700V toward 900V, the bidirectional inverters can implement a stepwise reduction in power output. This systematic reduction can be distinctly observable at incremental voltage thresholds, including 740V, 780V, 820V, and 860V, culminating at 900V. As a result the system can dynamically and reliably respond to varying DC voltage conditions. Ultimately, at a voltage level of 900V, the power output can stabilize at approximately 100%, reflecting the system's nominal operational state.

FIG. 5 illustrates process 500 performed by a processor to perform ride-through, according to at least one embodiment. Although process 500 is depicted as a series of steps or operations, it will be appreciated that at least one embodiment of process 500 includes altered or reordered steps or operations, or omits certain steps or operations, except where explicitly noted or logically required, such as when an output of one step or operation is used as input for another.

In at least one embodiment, the one or more entities may include components of the DC-based charging systems (e.g., system 100 illustrated in FIG. 1, system 200 illustrated in FIG. 2) such as, for example, AC grid 102, transformer 104, bidirectional inverter 106, combiner boxes 108, chargers 110, battery-powered vehicles (e.g., first battery-powered vehicle 112(1), second battery-powered vehicle 112(2), third battery-powered vehicle 112(3)), AC grid 202, bidirectional inverter 204, DC bus 206, chargers (e.g., first charger 208(1), second charger 208(2), third charger 208(3)), battery-powered vehicles (e.g., first battery-powered vehicle 214(1), second battery-powered vehicle 214(2)) illustrated in FIG. 2, entity 802, bidirectional inverter 804, charger 806, EV 808 illustrated in FIG. 8. The one or more entities may include the control systems for the components described in conjunction with FIG. 1.

Various functions can be carried out by a processor executing instructions stored in memory (e.g., computer-readable, machine-readable) to perform process 600. For example, the instructions may include a computer program persistently stored on magnetic, optical, or flash media. Also, process 500 may be implemented as computer-usable instructions (e.g., macro instruction, micro-instruction) stored on computer storage media or provided by a standalone application, a service, or hosted service (standalone or in combination with another hosted service).

At block 502, the one or more entities may determine that the voltage on the DC bus (e.g., DC bus 206 illustrated in FIG. 2) is below a threshold.

At block 504, the one or more entities may receive an indication that a battery-powered vehicle (first battery-powered vehicle 214(1) illustrated in FIG. 1) is plugged into one of the chargers (e.g., first charger 208(1) illustrated in FIG. 2).

At block 506, the one or more entities may prevent other chargers (e.g., group of chargers 216 illustrated in FIG. 2) from receiving power from the DC bus. Specifically, one or more entities can utilize blocking diodes in series with each branch circuit that connects to the other chargers. The one or more entities may utilize a physical break in the branch circuit, install DC circuit breakers or fuses, and deploy other devices—such as switches, controllers, or MOSFETs—to control the flow of current to and from the other chargers.

At block 508, the one or more entities may use the battery-charged vehicle to increase the voltage on the DC bus to exceed a threshold. The one or more entities may communicates directly with the battery-charged vehicle using protocols such as ISO 15118, which coordinates the optimal timing and amount of energy. The one or more entities may monitor key parameters like voltage, current, and temperature to regulate and safely manage the energy flow.

At block 510, the one or more entities may cause a bidirectional inverter (e.g., bidirectional inverter 106 illustrated in FIG. 1, bidirectional inverter 204 illustrated in FIG. 2) to convert AC voltage to DC voltage. At block 512, the one or more entities may allow the other chargers to receive power from the DC bus. At block 514, if there is fault within one or more components of charging system (e.g., system 100 illustrated in FIG. 1, system 200 illustrated in FIG. 2), process 500 may move to block 502. Conversely, process 500 may move to block 510 if there is no fault. In some embodiments, one or more of the operations performed in blocks 502, 504, 506, 508, 510, 512, and 514 may be performed in various orders and combinations, including in parallel.

FIG. 6 illustrates process 600 performed by a processor to perform droop control, according to at least one embodiment. Although process 600 is depicted as a series of steps or operations, it will be appreciated that at least one embodiment of process 600 includes altered or reordered steps or operations, or omits certain steps or operations, except where explicitly noted or logically required, such as when an output of one step or operation is used as input for another.

In at least one embodiment, the one or more entities may include components of the DC-based charging systems (e.g., system 100 illustrated in FIG. 1, system 200 illustrated in FIG. 2) such as, for example, AC grid 102, transformer 104, bidirectional inverter 106, combiner boxes 108, chargers 110, battery-powered vehicles (e.g., first battery-powered vehicle 112(1), second battery-powered vehicle 112(2), third battery-powered vehicle 112(3)), AC grid 202, bidirectional inverter 204, DC bus 206, chargers (e.g., first charger 208(1), second charger 208(2), third charger 208(3)), battery-powered vehicles (e.g., first battery-powered vehicle 214(1), second battery-powered vehicle 214(2)) illustrated in FIG. 2, entity 802, bidirectional inverter 804, charger 806, EV 808 illustrated in FIG. 8. The one or more entities may include the control systems for the components described in conjunction with FIG. 1.

Various functions can be carried out by a processor executing instructions stored in memory (e.g., computer-readable, machine-readable) to perform process 600. For example, the instructions may include a computer program persistently stored on magnetic, optical, or flash media. Also, process 600 may be implemented as computer-usable instructions (e.g., macro instruction, micro-instruction) stored on computer storage media or provided by a standalone application, a service, or hosted service (standalone or in combination with another hosted service).

At block 602, the one or more entities identify that the power required for battery-powered vehicles (e.g., first battery-powered vehicle 112(1), second battery-powered vehicle 112(2), third battery-powered vehicle 112(3) illustrated in FIG. 1, first battery-powered vehicle 214(1), second battery-powered vehicle 214(2) illustrated in FIG. 2) electrically coupled to the charging system (e.g., system 100 illustrated in FIG. 1, system 200 illustrated in FIG. 2) has changed.

At block 604, the one or more entities cause a bidirectional inverter (e.g., bidirectional inverter 106 illustrated in FIG. 1, bidirectional inverter 204 illustrated in FIG. 2) to adjust the DC voltage, with the adjustment being based on the DC voltage being inversely proportional to the power. Example graph 400 in FIG. 4 illustrates how the DC voltage can change based on the power and vice versa.

At block 606, the one or more entities cause chargers (e.g., chargers 110 illustrated in FIG. 1, first charger 208(1), second charger 208(2), third charger 208(3) illustrated in FIG. 2) to adjust their power consumption in proportion to the DC voltage. This setup can cause both the bidirectional inverter and the chargers to adjust their power consumption and voltage without having to communicate with each other.

At block 608, the one or more entities may supply power to the battery powered chargers based on the adjusted DC voltage. At block 610, if there is a change in power requirements due to the number of battery-powered chargers currently connected to the charging system, the battery configurations of these chargers, or a change in the total number of chargers within the system, process 600 can proceed to block 602. Conversely, process 600 can move to block 608 if there is no change. In some embodiments, one or more of the operations performed in blocks 602, 604, 606, 608, and 610 may be performed in various orders and combinations, including in parallel.

FIG. 7 illustrates process 700 performed by a processor to perform ride-through, according to at least one embodiment. Although process 700 is depicted as a series of steps or operations, it will be appreciated that at least one embodiment of process 700 includes altered or reordered steps or operations, or omits certain steps or operations, except where explicitly noted or logically required, such as when an output of one step or operation is used as input for another. One or more entities described in conjunction with FIGS. 1, 2, and 8, singly or in any combination, can perform each block of process 700.

In at least one embodiment, the one or more entities may include components of the DC-based charging systems (e.g., system 100 illustrated in FIG. 1, system 200 illustrated in FIG. 2) such as, for example, AC grid 102, transformer 104, bidirectional inverter 106, combiner boxes 108, chargers 110, battery-powered vehicles (e.g., first battery-powered vehicle 112(1), second battery-powered vehicle 112(2), third battery-powered vehicle 112(3)), AC grid 202, bidirectional inverter 204, DC bus 206, chargers (e.g., first charger 208(1), second charger 208(2), third charger 208(3)), battery-powered vehicles (e.g., first battery-powered vehicle 214(1), second battery-powered vehicle 214(2)) illustrated in FIG. 2, entity 802, bidirectional inverter 804, charger 806, EV 808 illustrated in FIG. 8. The one or more entities may include the control systems for the components described in conjunction with FIG. 1.

Various functions can be carried out by a processor executing instructions stored in memory (e.g., computer-readable, machine-readable) to perform process 700. For example, the instructions may include a computer program persistently stored on magnetic, optical, or flash media. Also, process 700 may be implemented as computer-usable instructions (e.g., macro instruction, micro-instruction) stored on computer storage media or provided by a standalone application, a service, or hosted service (standalone or in combination with another hosted service).

At block 702, the one or more entities may identify that the voltage (e.g., AC voltage from transformers and/or AC grids, DC voltage from bidirectional inverters) has decreased to a certain level. At block 702, the one or more entities may determine that a predetermined duration has passed and process 700 can proceed to block 706 if the duration has not been passed. Conversely, process 700 can proceed to block 712 if the duration has passed.

At block 706, the one or more entities may cause a bidirectional inverter (e.g., bidirectional inverter 106 illustrated in FIG. 1, bidirectional inverter 204 illustrated in FIG. 2) to continue converting AC voltage to DC voltage. At block 708, the one or more entities may determine whether the voltage returns to a reference voltage and process 700 can proceed to block 710 if the voltage returns to the reference voltage. Conversely, process 700 can proceed to block 702 if the voltage is less than the reference voltage. In some examples, the reference voltage can be lower than the voltage before it has been decreased.

At block 710, the one or more entities may cause the bidirectional inverter to continue converting the AC voltage to DC voltage such that chargers (e.g., chargers 110 illustrated in FIG. 1, first charger 208(1), second charger 208(2), third charger 208(3) illustrated in FIG. 2) can feed power to battery-powered vehicles (e.g., first battery-powered vehicle 112(1), second battery-powered vehicle 112(2), third battery-powered vehicle 112(3) illustrated in FIG. 1, first battery-powered vehicle 214(1), second battery-powered vehicle 214(2) illustrated in FIG. 2).

At block 712, the one or more entities may prevent the bidirectional inverter from converting AC voltage to DC voltage. In some embodiments, one or more of the operations performed in blocks 702, 704, 706, 708, 710, and 712 may be performed in various orders and combinations, including in parallel.

Any system or apparatus feature described herein may also be provided as a method feature, and vice versa. System and/or apparatus aspects described functionally (including means-plus-function features) may be expressed alternatively in terms of their corresponding structure, such as a suitably programmed processor and associated memory. It should also be appreciated that particular combinations of the various features described and defined in any aspect of the present disclosure can be implemented, supplied, and used independently.

Any system or apparatus feature described herein can include computer programs and computer program products comprising software code adapted, when executed on a data processing apparatus, to perform any of the methods and/or embody any of the apparatus and system features described herein, including any or all of the component steps of any method. Any system or apparatus feature described herein can also include a computer or computing system (including networked or distributed systems) having an operating system that supports a computer program for carrying out any of the methods described herein and/or embodying any of the apparatus or system features described herein. Any system or apparatus feature described herein can also include computer-readable media having stored thereon any one or more of the computer programs aforesaid. Any system or apparatus feature described herein can include a signal carrying any one or more of the computer programs aforesaid.

Note that, in the context of describing disclosed embodiments, unless otherwise specified, the use of expressions regarding executable instructions (also referred to as code, applications, agents) performing operations that “instructions” do not ordinarily perform unaided (e.g., transmission of data, calculations) denotes that the instructions are being executed by a machine, thereby causing the machine to perform the specified operations.

FIG. 8 illustrates process 800 performed by at least one processor to initiate a bidirectional inverter, according to at least one embodiment. In some examples, one or more systems can perform process 800, where the one or more systems may include entity 802, bidirectional inverter 804, charger 806, and battery-powered vehicle 806.

In at least one embodiment, process 800 may include entity 802 setting up 810 target DC voltage. In some examples, entity 802 may refer to the one or more control systems described in conjunction with FIG. 1. Entity 802 may further send a start command to bidirectional inverter 804.

Process 800 may further include bidirectional inverter 804 applying 812 DC voltage lower than the target DC voltage. In some examples, bidirectional inverter 804 may refer to power electronic device configured to convert alternating current (AC) electrical power from an AC grid into direct current (DC) to establish and maintain a regulated DC bus.

Process 800 may further include bidirectional inverter 804 establishing 814 the DC voltage within predetermined time frame. Process 800 may further include bidirectional inverter 804 closing 816 main input breaker and increase the DC volage to target voltage.

Process 800 may further include charger 806 controlling 818 output DC voltage. In some examples, charger 806 may refer to a DC-powered device configured to receive direct current (DC) electricity from a combiner box, and to regulate and condition the received DC power to appropriate voltage and current levels required to safely charge an electric vehicle's onboard battery.

Process 800 may further include charger 806 completing 820 input pre-charge. Process 800 may further include battery-powered vehicle 808 to be plugged into 822 charger 806. In some examples, battery-powered vehicle 808 may refer to any mode of transportation propelled primarily or exclusively by electric energy stored in onboard rechargeable battery packs. Process 800 may further include charger 806 performing 824 handshaking. Process 800 may further include charger 806 starting 826 charging battery-powered vehicle 808.

FIG. 9 illustrates aspects of an example system 900 for implementing aspects in accordance with an embodiment. As will be appreciated, although a web-based system is used for purposes of explanation, different systems may be used, as appropriate, to implement various embodiments. In an embodiment, the system includes an electronic client device 902, which includes any appropriate device operable to send and/or receive requests, messages, or information over an appropriate network 904 and convey information back to a user of the device. Examples of such client devices include personal computers, cellular or other mobile phones, handheld messaging devices, laptop computers, tablet computers, set-top boxes, personal data assistants, embedded computer systems, electronic book readers, and the like. In an embodiment, the network includes any appropriate network, including an intranet, the Internet, a cellular network, a local area network, a satellite network or any other such network and/or combination thereof, and components used for such a system depend at least in part upon the type of network and/or system selected. Many protocols and components for communicating via such a network are well known and will not be discussed herein in detail. In an embodiment, communication over the network is enabled by wired and/or wireless connections and combinations thereof. In an embodiment, the network includes the Internet and/or other publicly addressable communications network, as the system includes a web server 906 for receiving requests and serving content in response thereto, although for other networks an alternative device serving a similar purpose could be used as would be apparent to one of ordinary skill in the art.

In an embodiment, the illustrative system includes at least one application server 908 and a data store 910, and it should be understood that there can be several application servers, layers or other elements, processes or components, which may be chained or otherwise configured, which can interact to perform tasks such as obtaining data from an appropriate data store. Servers, in an embodiment, are implemented as hardware devices, virtual computer systems, programming modules being executed on a computer system, and/or other devices configured with hardware and/or software to receive and respond to communications (e.g., web service application programming interface (API) requests) over a network. As used herein, unless otherwise stated or clear from context, the term “data store” refers to any device or combination of devices capable of storing, accessing and retrieving data, which may include any combination and number of data servers, databases, data storage devices and data storage media, in any standard, distributed, virtual or clustered system. Data stores, in an embodiment, communicate with block-level and/or object-level interfaces. The application server can include any appropriate hardware, software and firmware for integrating with the data store as needed to execute aspects of one or more applications for the client device, handling some or all of the data access and business logic for an application.

In an embodiment, the application server provides access control services in cooperation with the data store and generates content including but not limited to text, graphics, audio, video and/or other content that is provided to a user associated with the client device by the web server in the form of HyperText Markup Language (“HTML”), Extensible Markup Language (“XML”), JavaScript, Cascading Style Sheets (“CSS”), JavaScript Object Notation (JSON), and/or another appropriate client-side or other structured language. Content transferred to a client device, in an embodiment, is processed by the client device to provide the content in one or more forms including but not limited to forms that are perceptible to the user audibly, visually and/or through other senses. The handling of all requests and responses, as well as the delivery of content between the client device 902 and the application server 908, in an embodiment, is handled by the web server using PHP: Hypertext Preprocessor (“PHP”), Python, Ruby, Perl, Java, HTML, XML, JSON, and/or another appropriate server-side structured language in this example. In an embodiment, operations described herein as being performed by a single device are performed collectively by multiple devices that form a distributed and/or virtual system.

The data store 910, in an embodiment, includes several separate data tables, databases, data documents, dynamic data storage schemes and/or other data storage mechanisms and media for storing data relating to a particular aspect of the present disclosure. In an embodiment, the data store illustrated includes mechanisms for storing production data 912 and user information 916, which are used to serve content for the production side. The data store also is shown to include a mechanism for storing log data 914, which is used, in an embodiment, for reporting, computing resource management, analysis or other such purposes. In an embodiment, other aspects such as page image information and access rights information (e.g., access control policies or other encodings of permissions) are stored in the data store in any of the above listed mechanisms as appropriate or in additional mechanisms in the data store 910.

The data store 910, in an embodiment, is operable, through logic associated therewith, to receive instructions from the application server 908 and obtain, update or otherwise process data in response thereto, and the application server 908 provides static, dynamic, or a combination of static and dynamic data in response to the received instructions. In an embodiment, dynamic data, such as data used in web logs (blogs), shopping applications, news services, and other such applications, are generated by server-side structured languages as described herein or are provided by a content management system (“CMS”) operating on or under the control of the application server. In an embodiment, a user, through a device operated by the user, submits a search request for a certain type of item. In this example, the data store accesses the user information to verify the identity of the user, accesses the catalog detail information to obtain information about items of that type, and returns the information to the user, such as in a results listing on a web page that the user views via a browser on the user device 902. Continuing with this example, information for a particular item of interest is viewed in a dedicated page or window of the browser. It should be noted, however, that embodiments of the present disclosure are not necessarily limited to the context of web pages, but are more generally applicable to processing requests in general, where the requests are not necessarily requests for content. Example requests include requests to manage and/or interact with computing resources hosted by the system 900 and/or another system, such as for launching, terminating, deleting, modifying, reading, and/or otherwise accessing such computing resources.

In an embodiment, each server typically includes an operating system that provides executable program instructions for the general administration and operation of that server and includes a computer-readable storage medium (e.g., a hard disk, random access memory, read only memory, etc.) storing instructions that, if executed by a processor of the server, cause or otherwise allow the server to perform its intended functions (e.g., the functions are performed as a result of one or more processors of the server executing instructions stored on a computer-readable storage medium).

The system 900, in an embodiment, is a distributed and/or virtual computing system utilizing several computer systems and components that are interconnected via communication links (e.g., transmission control protocol (TCP) connections and/or transport layer security (TLS) or other cryptographically protected communication sessions), using one or more computer networks or direct connections. However, it will be appreciated by those of ordinary skill in the art that such a system could operate in a system having fewer or a greater number of components than are illustrated in FIG. 9. Thus, the depiction of the system 900 in FIG. 9 should be taken as being illustrative in nature and not limiting to the scope of the disclosure.

The various embodiments further can be implemented in a wide variety of operating environments, which in some cases can include one or more user computers, computing devices or processing devices that can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python or TCL, as well as combinations thereof. In an embodiment, the one or more servers also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. In an embodiment, a database server includes table-based servers, document-based servers, unstructured servers, relational servers, non-relational servers, or combinations of these and/or other database servers.

In an embodiment, the system includes a variety of data stores and other memory and storage media as discussed above that can reside in a variety of locations, such as on a storage medium local to (and/or resident in) one or more of the computers or remote from any or all of the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

At least one embodiment of the disclosure can be described in view of the following clauses:
1. A direct current (DC) charging apparatus, comprising:
   a transformer to step down alternating current (AC) voltage from an AC grid before providing stepped-down AC voltage to a bidirectional inverter electrically coupled to the transformer and a DC bus;
   a plurality of DC to DC converters electrically coupled to the DC bus to charge one or more battery-powered vehicles;
   one or more processors; and
   memory that stores computer-executable instructions that, if executed, cause the one or more processors to:
      as a result of determining that the voltage on the DC bus is below a threshold, cause one of the one or more battery-powered vehicles electrically coupled to one of the plurality of DC to DC converters to increase the voltage on DC bus; as a result of determining that the voltage on the DC bus is above the threshold, cause the bidirectional inverter to convert the stepped-down AC voltage from the transformer to DC voltage to be provided to the DC bus to charge the one or more battery-powered vehicles;
      cause the bidirectional inverter to adjust the DC voltage to be inversely proportional to an amount of power to charge the one or more battery-powered vehicles electrically coupled to the plurality of DC to DC converters,
      wherein individual power consumption for each DC to DC converter is proportional to the DC voltage; and
      in response to a decrease of the adjusted DC voltage caused by a fault of the DC charging apparatus, cause the bidirectional inverter to continue converting the stepped-down AC voltage for a predetermined amount of time.
2. The DC charging apparatus of clause 1, wherein the DC bus comprises a plurality of branch circuits that is electrically coupled to the plurality of DC to DC converters, wherein each of the plurality of branch circuits comprises a circuit breaker.
3. The DC charging apparatus of clause 1 or 2, further comprising a solar panel or a battery to increase the voltage on the DC bus when the voltage is below the threshold.
4. The DC charging apparatus of any of clauses 1-3, wherein the computer-executable instructions further include computer-executable instructions that, if executed, cause the one or more processors to:
   identify that the adjusted DC voltage has reached a reference voltage; and
   in response to the identification, cause the bidirectional inverter to continue converting the stepped-down AC voltage to charge the one or more battery-powered vehicles.
5. A system comprising:
   a bidirectional inverter electrically coupled to an alternating current (AC) grid and a direct current (DC) bus;
   a plurality of DC to DC converters electrically coupled to the DC bus to charge one or more battery-powered vehicles;
   one or more processors; and
   memory that stores computer-executable instructions that, if executed, cause the one or more processors to:
      in response to determining that voltage on DC bus is above a threshold, cause the bidirectional inverter to convert AC voltage from the AC grid to DC voltage to be provided to the DC bus to charge one or more battery-powered vehicles; and
      cause the bidirectional inverter to adjust the DC voltage to be inversely proportional to an amount of power to charge the one or more battery-powered vehicles electrically coupled to the plurality of DC to DC converters, wherein load for a DC to DC converter of the plurality of DC to DC converters is proportional to the DC voltage.
6. The system of clause 5, wherein the computer-executable instructions further include computer-executable instructions that, if executed, cause the one or more processors to:
   identify a battery-powered vehicle of the one or more battery-powered vehicles that is electrically coupled to the DC to DC converter of the plurality of DC to DC converters; and
   cause other DC to DC converters of the plurality of DC to DC converters to be prevented from receiving power from the DC to DC converter.
7. The system of clause 5 or 6, wherein the computer-executable instructions further include computer-executable instructions that, if executed, cause the one or more processors to:
   cause the battery-powered vehicle electrically coupled to the DC to DC converter of the plurality of DC to DC converters to increase the voltage on the DC bus to exceed the threshold.
8. The system of any of clauses 5-7, wherein:
   the DC voltage is between 700V and 1000V; and
   the AC voltage is between 480V and 800V.
9. The system of any of clauses 5-8, wherein the computer-executable instructions further include computer-executable instructions that, if executed, cause the one or more processors to:
   in response to a decrease of the adjusted DC voltage as a result of a fault of the system, cause the bidirectional inverter to continue converting the AC voltage for a predetermined amount of time.
10. The system of any of clauses 5-9, further comprising:
   a controller system to identify sequence of supplying power by the plurality of DC to DC converters based, at least in part, on status indicators received from one or more battery-powered vehicles.
11. The system of any of clauses 5-10, wherein the computer-executable instructions further include computer-executable instructions that, if executed, cause the one or more processors to:
   generate a random value; and
   use the random value to set a delay for the other DC to DC converters to receive DC voltage before charging the one or more battery-powered vehicles.
12. The system of any of clauses 5-11, wherein the DC bus comprises a plurality of branch circuits with circuit breakers to be electrically coupled to the plurality of DC to DC converters.
13. A method comprising:
   determining that a voltage on direct current (DC) bus coupled to a plurality of DC to DC converters and a bidirectional inverter is below a threshold;
   receiving an indication that a battery-powered vehicle is electrically coupled to a DC to DC converter of the plurality of DC to DC converters;
   preventing other DC to DC converters of the plurality of DC to DC converters receiving power to the DC bus until the voltage of the DC bus exceeds the threshold;
   causing the DC to DC converter of the plurality of DC to DC converters to increase the voltage on the DC bus;
   causing the bidirectional inverter to convert AC voltage from an alternating current (AC) grid to DC voltage as a result of determining that the voltage of the DC bus exceeds the threshold;
   causing the other DC to DC converters of the plurality of DC to DC converters to be allowed to be electrically coupled to the DC bus; and
   causing at least one of the other DC to DC converters to charge one or more other battery-powered vehicles based, at least in part, on the DC voltage.
14. The method of clause 13, further comprising:
   causing the bidirectional inverter to modify the DC voltage to be inversely proportional to a number of battery-powered vehicles electrically coupled to the plurality of DC to DC converters, wherein power consumption for a DC to DC converter of the plurality of DC to DC converters is proportional to the modified DC voltage.
15. The method of clause 13 or 14, further comprising:
   in response to a decrease of the AC voltage due to a fault of the AC grid, causing the bidirectional inverter to continue converting the AC voltage to the DC voltage for a predetermined amount of time.
16. The method of any of clauses 13-15, further comprising:
   as a result of identifying that the DC voltage has returned to a reference voltage, causing the bidirectional inverter to continue converting the AC voltage, wherein the reference voltage is lower than the DC voltage.
17. The method of any of clauses 13-16, further comprising:
   causing a transformer to step down the AC voltage before the stepped-down AC voltage is converted by the bidirectional inverter.
18. The method of any of clauses 13-17, wherein the DC bus comprises a plurality of branch circuits to be electrically coupled to the plurality of DC to DC converters, wherein at least one of the plurality of branch circuits comprises a circuit breaker.
19. The method of any of clauses 13-18, further comprising:
   generating a random value; and
   using the random value to set a delay for the other DC to DC converters to receive DC voltage before charging one or more other battery-powered vehicles.
20. The method of any of clauses 13-19, wherein:
   the plurality of DC to DC converters use ISO 15118 or DIN 70121 to set point with the one or more other battery-powered vehicles; and
   open charge point protocol (OCPP), Modbus, Distributed Network Protocol 3(DNP3), or Open Platform Communications Unified Architecture (OPC-UA) are used to charge the one or more other battery-powered vehicles.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein

What is claimed is:

1. A direct current (DC) charging apparatus, comprising:
a transformer to step down alternating current (AC) voltage from an AC grid before providing stepped-down AC voltage to a bidirectional inverter electrically coupled to the transformer and a DC bus;
a plurality of DC to DC converters electrically coupled to the DC bus to charge one or more battery-powered vehicles;
one or more processors; and
memory that stores computer-executable instructions that, if executed, cause the one or more processors to:
as a result of determining that the voltage on the DC bus is below a threshold, cause one of the one or more battery-powered vehicles electrically coupled to one of the plurality of DC to DC converters to increase the voltage on DC bus;
as a result of determining that the voltage on the DC bus is above the threshold, cause the bidirectional inverter to convert the stepped-down AC voltage from the transformer to DC voltage to be provided to the DC bus to charge the one or more battery-powered vehicles;
cause the bidirectional inverter to adjust the DC voltage to be inversely proportional to an amount of power to charge the one or more battery-powered vehicles electrically coupled to the plurality of DC to DC converters,
wherein individual power consumption for each DC to DC converter is proportional to the DC voltage; and
in response to a decrease of the adjusted DC voltage caused by a fault of the DC charging apparatus, cause the bidirectional inverter to continue converting the stepped-down AC voltage for a predetermined amount of time.

2. The DC charging apparatus of claim 1, wherein the DC bus comprises a plurality of branch circuits that is electrically coupled to the plurality of DC to DC converters, wherein each of the plurality of branch circuits comprises a circuit breaker.

3. The DC charging apparatus of claim 1, further comprising a solar panel or a battery to increase the voltage on the DC bus when the voltage is below the threshold.

4. The DC charging apparatus of claim 1, wherein the computer-executable instructions further include computer-executable instructions that, if executed, cause the one or more processors to:
identify that the adjusted DC voltage has reached a reference voltage; and
in response to the identification, cause the bidirectional inverter to continue converting the stepped-down AC voltage to charge the one or more battery-powered vehicles.

5. A system comprising:
a bidirectional inverter electrically coupled to an alternating current (AC) grid and a direct current (DC) bus;
a plurality of DC to DC converters electrically coupled to the DC bus to charge one or more battery-powered vehicles;
one or more processors; and
memory that stores computer-executable instructions that, if executed, cause the one or more processors to:
in response to determining that voltage on DC bus is above a threshold, cause the bidirectional inverter to convert AC voltage from the AC grid to DC voltage to be provided to the DC bus to charge one or more battery-powered vehicles; and
cause the bidirectional inverter to adjust the DC voltage to be inversely proportional to an amount of power to charge the one or more battery-powered vehicles electrically coupled to the plurality of DC to DC converters, wherein load for a DC to DC converter of the plurality of DC to DC converters is proportional to the DC voltage.

6. The system of claim 5, wherein the computer-executable instructions further include computer-executable instructions that, if executed, cause the one or more processors to:
identify a battery-powered vehicle of the one or more battery-powered vehicles that is electrically coupled to the DC to DC converter of the plurality of DC to DC converters; and
cause other DC to DC converters of the plurality of DC to DC converters to be prevented from receiving power from the DC to DC converter.

7. The system of claim 6, wherein the computer-executable instructions further include computer-executable instructions that, if executed, cause the one or more processors to:
cause the battery-powered vehicle electrically coupled to the DC to DC converter of the plurality of DC to DC converters to increase the voltage on the DC bus to exceed the threshold.

8. The system of claim 5, wherein:
the DC voltage is between 700V and 1000V; and
the AC voltage is between 480V and 800V.

9. The system of claim 5, wherein the computer-executable instructions further include computer-executable instructions that, if executed, cause the one or more processors to:
in response to a decrease of the adjusted DC voltage as a result of a fault of the system, cause the bidirectional inverter to continue converting the AC voltage for a predetermined amount of time.

10. The system of claim 5, further comprising:
a controller system to identify sequence of supplying power by the plurality of DC to DC converters based, at least in part, on status indicators received from one or more battery-powered vehicles.

11. The system of claim 5, wherein the computer-executable instructions further include computer-executable instructions that, if executed, cause the one or more processors to:
generate a random value; and
use the random value to set a delay for the other DC to DC converters to receive DC voltage before charging the one or more battery-powered vehicles.

12. The system of claim 5, wherein the DC bus comprises a plurality of branch circuits with circuit breakers to be electrically coupled to the plurality of DC to DC converters.

13. A method comprising:
determining that a voltage on direct current (DC) bus coupled to a plurality of DC to DC converters and a bidirectional inverter is below a threshold;
receiving an indication that a battery-powered vehicle is electrically coupled to a DC to DC converter of the plurality of DC to DC converters;
preventing other DC to DC converters of the plurality of DC to DC converters receiving power to the DC bus until the voltage of the DC bus exceeds the threshold;
causing the DC to DC converter of the plurality of DC to DC converters to increase the voltage on the DC bus;
causing the bidirectional inverter to convert AC voltage from an alternating current (AC) grid to DC voltage as a result of determining that the voltage of the DC bus exceeds the threshold;
causing the other DC to DC converters of the plurality of DC to DC converters to be allowed to be electrically coupled to the DC bus; and
causing at least one of the other DC to DC converters to charge one or more other battery-powered vehicles based, at least in part, on the DC voltage.

14. The method of claim 13, further comprising:
causing the bidirectional inverter to modify the DC voltage to be inversely proportional to a number of battery-powered vehicles electrically coupled to the plurality of DC to DC converters, wherein power consumption for a DC to DC converter of the plurality of DC to DC converters is proportional to the modified DC voltage.

15. The method of claim 13, further comprising:
in response to a decrease of the AC voltage due to a fault of the AC grid, causing the bidirectional inverter to continue converting the AC voltage to the DC voltage for a predetermined amount of time.

16. The method of claim 15, further comprising:
as a result of identifying that the DC voltage has returned to a reference voltage, causing the bidirectional inverter to continue converting the AC voltage, wherein the reference voltage is lower than the DC voltage.

17. The method of claim 13, further comprising:
causing a transformer to step down the AC voltage before the stepped-down AC voltage is converted by the bidirectional inverter.

18. The method of claim 13, wherein the DC bus comprises a plurality of branch circuits to be electrically coupled to the plurality of DC to DC converters, wherein at least one of the plurality of branch circuits comprises a circuit breaker.

19. The method of claim 13, further comprising:
generating a random value; and
using the random value to set a delay for the other DC to DC converters to receive DC voltage before charging one or more other battery-powered vehicles.

20. The method of claim 13, wherein:
the plurality of DC to DC converters use ISO 15118 or DIN 70121 to set point with the one or more other battery-powered vehicles; and
open charge point protocol (OCPP), Modbus, Distributed Network Protocol 3(DNP3), or Open Platform Communications Unified Architecture (OPC-UA) are used to charge the one or more other battery-powered vehicles.
